(19) United States
(12) Patent Application Publication
(10) Pub. No.: US 2010/0246435 A1
(43) Pub. Date: Sep. 30, 2010

(54) Method and apparatus for new cell discovery

(76) Inventors: Van Minh Nguyen, Le-Kremlin-Bicetre (FR); Yacine El Mghazil, Arcueil (FR)

Correspondence Address: Alcatel-Lucent USA Inc.,;Docket Administrator, Room 2F-192, 600-700 Mountain Ave., Murray Hill, NJ, 07974-0636, US

(21) Appl. No.: 12/383,907

(22) Filed: Mar. 30, 2009

(51) Int. Cl. H04L 12/28; H04B 1/38

(52) U.S. Cl. 370/254; 455/73

(57) ABSTRACT

To address the need for new techniques to improve the discovery of neighbor cells, methods such as those depicted in diagrams 10 or 20 may be employed. In one method, a network node sends (11) to a remote unit an indication of at least one timeslot during which NCL scanning is to be performed. It further indicates (12) that the at least one timeslot is to be additionally used to search for signaling from cells not included in an NCL associated with the remote unit. In another method, a remote unit receives (21) an indication of at least one timeslot during which NCL scanning is to be performed. During the at least one timeslot, the remote unit measures (22) signaling from at least one cell included in an NCL associated with the remote unit and searches (23) for signaling from cells not included in the NCL.

### FIELD OF THE INVENTION

The present invention relates generally to communication systems and, in particular, to new cell discovery in communication systems.

### BACKGROUND OF THE INVENTION

A goal in the development of cellular wireless networks is to design autonomous networks that reduce the level of human intervention required and that enhance network performance generally. Examples of such work include the standards work on self-organization functions underway in IEEE (Institute of Electrical and Electronics Engineers) 802.16m and 3GPP (3rd Generation Partnership Project) LTE (Long Term Evolution).

Conceptually a self-organization function senses the environment and then responds itself to dynamic changes with intelligent decisions in order to reach the optimal operational state of the network. The sensing phase includes, for example, discovering, detecting, and/or measuring, etc. Especially for mobility management over the radio interface, the sensing of neighboring cells plays a key factor; e.g., it enhances the quality of the handover target cell and of handover in general.

Thus, it would be clearly desirable to have new techniques that are able to improve the discovery of new neighbor cells.

### BRIEF DESCRIPTION OF THE DRAWINGS

FIG. 1 is a logic flow diagram of functionality performed by a network node in accordance with various embodiments of the present invention.

FIG. 2 is a logic flow diagram of functionality performed by a remote unit in accordance with various embodiments of the present invention.

FIG. 3 is a block diagram depiction of a communication system in accordance with multiple embodiments of the present invention.

FIG. 4 is a detailed block diagram depiction of a wireless communication system in accordance with certain embodiments for new cell discovery within a timeslot.

FIG. 5 is a detailed block diagram depiction of a wireless communication system in accordance with certain embodiments for new cell discovery using multiple MSs.

FIG. 6 is a detailed block diagram depiction of a wireless communication system in accordance with certain embodiments for new cell discovery using multiple timeslots.

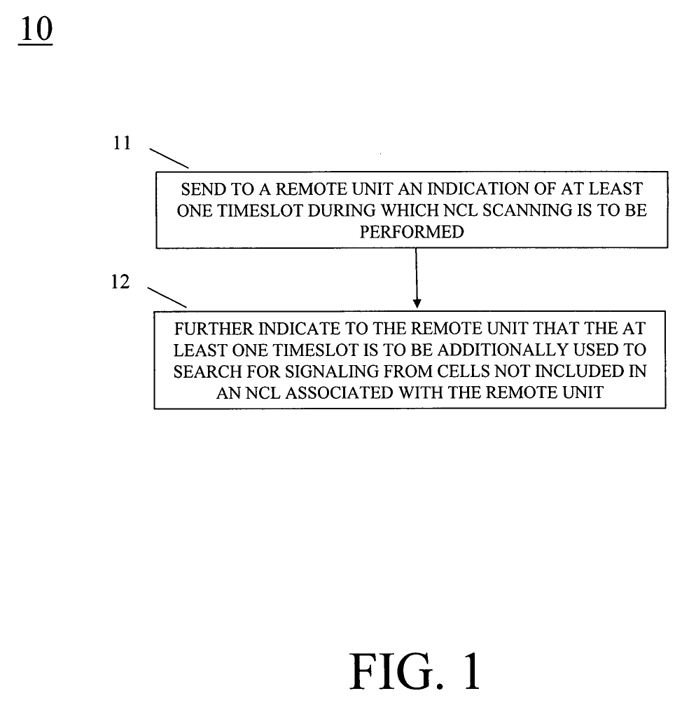

Specific embodiments of the present invention are disclosed below with reference to FIGS. 1-6. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

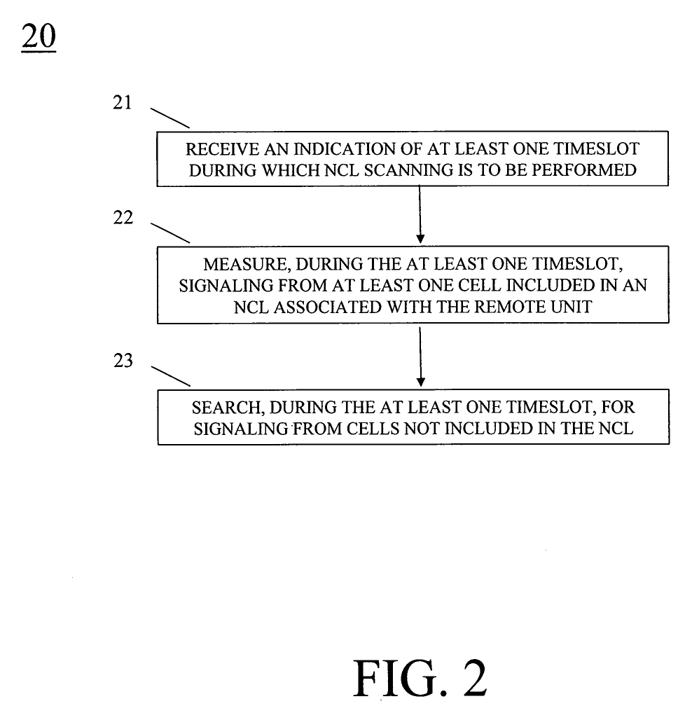

To address the need to have new techniques that are able to improve the discovery of new neighbor cells, methods such as those depicted in diagram 10 or 20 of FIGS. 1 and 2 may be employed. In one method, a network node sends (11) to a remote unit an indication of at least one timeslot during which neighbor cell list (NCL) scanning is to be performed. It further indicates (12) that the at least one timeslot is to be additionally used to search for signaling from cells not included in an NCL associated with the remote unit. In another method, a remote unit receives (21) an indication of at least one timeslot during which NCL scanning is to be performed. During the at least one timeslot, the remote unit measures (22) signaling from at least one cell included in an NCL associated with the remote unit and searches (23) for signaling from cells not included in the NCL.

### DETAILED DESCRIPTION OF EMBODIMENTS

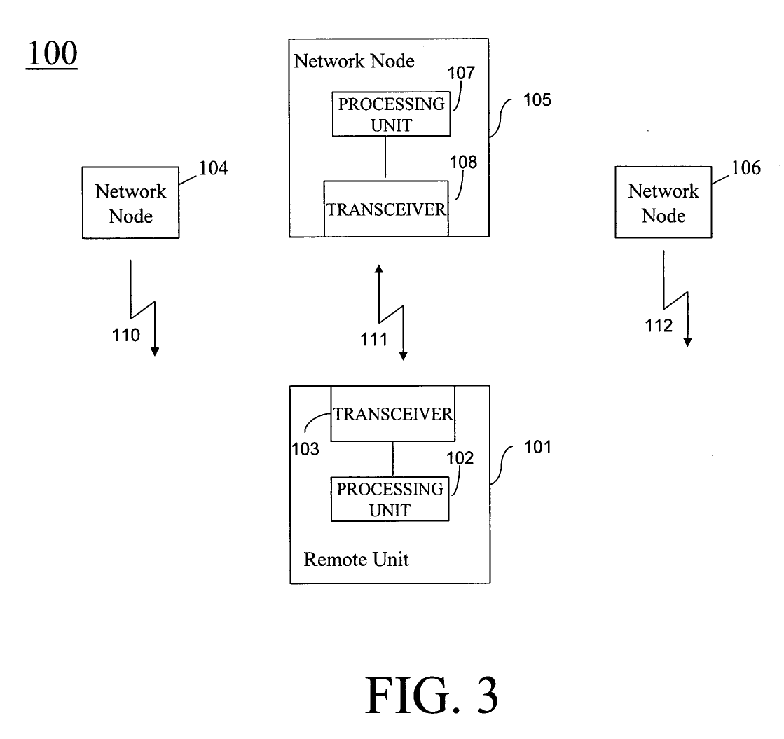

The present invention can be more fully understood with reference to FIGS. 3-6. FIG. 3 is a block diagram depiction of a communication system in accordance with multiple embodiments of the present invention. It should be understood that wireless communication systems typically include a plurality of mobile units, a plurality of network nodes, and additional equipment; however, only remote unit 101 and network nodes 104-106 are depicted in diagram 100 for the sake of clarity.

Network nodes 104-106 are network elements that provide over the air communication with mobile units. For example, depending on the technologies involved, a network node may be embodied in-part or in-full as, or within, a base station, an access point, and/or an access network. Network nodes 104-106 transmit signaling via technology-dependent, wireless interfaces 110-112.

Remote unit 101 is shown communicating with network node 105 via technology-dependent, wireless interface 111. Remote units may also be referred to as user equipment (UEs). In addition, remote unit platforms are known to span a wide variety of consumer electronic platforms such as, but not limited to, Voice over IP (VoIP) phones, mobile stations (MSs), access terminals (ATs), terminal equipment, mobile devices, gaming devices, personal computers, personal digital assistants (PDAs), and any other mobile equipment capable of being used in a wireless system.

FIG. 3 depicts network node 105 and remote unit 101 as respectively comprising processing units 107 and 102 and transceivers 108 and 103. In general, components such as processing units and transceivers are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, network node 105 and remote unit 101 represent known devices that have been adapted, in accordance with the description herein, to implement multiple embodiments of the present invention. Furthermore, those skilled in the art will recognize that aspects of the present invention may be implemented in and across various physical components and none are necessarily limited to single platform implementations. For example, processing unit 107 and transceiver 108 may be implemented in or across one or more network components, such as one or more base transceiver stations or one or more base stations (BSs). Remote unit 101 comprises processing unit 102 and transceiver 103. Depending on the embodiment, remote unit 101 may additionally comprise a keypad (not shown), a speaker (not shown), a microphone (not shown), and a display (not shown). Processing units, transceivers, keypads, speakers, microphones, and displays as used in wireless device are all well-known in the art.

Operation of embodiments in accordance with the present invention occurs substantially as follows, first with reference to FIG. 3. Processing unit 107 of network node 105 sends to remote unit 101, via transceiver 108, an indication of at least one timeslot during which neighbor cell list (NCL) scanning is to be performed by remote unit 101. Processing unit 107 also indicates to remote unit 101, via transceiver 108, that the at least one timeslot is to be additionally used to search for signaling from cells not included in an NCL associated with the remote unit.

Processing unit 102 of remote unit 101 receives via transceiver 103 an indication of at least one timeslot during which NCL scanning is to be performed. During the at least one timeslot, processing unit 102 via transceiver 103 measures signaling from at least one cell included in an NCL associated with remote unit 101 and also searches for signaling from cells not included in the NCL. For example, if a cell associated with network node 104 is in remote unit 101's NCL but a cell associated with network node 106 is not, then remote unit 101 uses the at least one timeslot to both measure signaling 110 and search for (perhaps detecting/discovering) signaling 112.

Depending on the embodiment, processing unit 107 of network node 105 may indicate a frequency on which remote unit 101 should perform NCL scanning during the one or more timeslots. In some embodiments, processing unit 107 of network node 105 may indicate a first frequency on which either NCL scanning or neighbor discovery (or both) is to be performed by remote unit 101 during a first timeslot and a second frequency on which either NCL scanning or neighbor discovery (or both) is to be performed during a second timeslot.

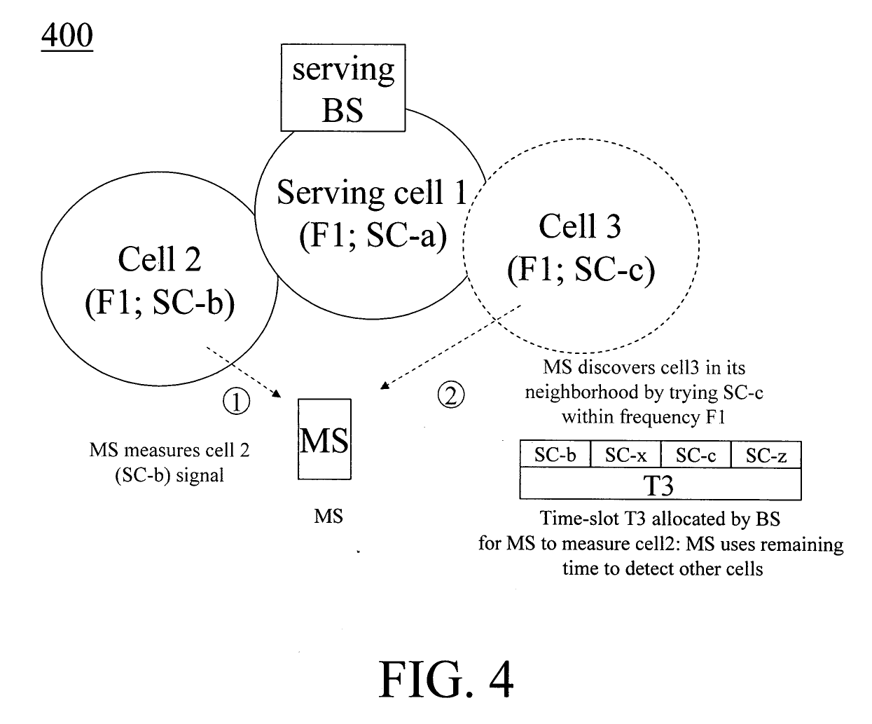

To provide a greater degree of detail in making and using various aspects of the present invention, a description of certain, quite specific, embodiments follows for the sake of example. FIGS. 4-6 provide detailed block diagram depictions of wireless communication systems in accordance with certain embodiments of the present invention.

Cellular networks based on wideband physical layer such as CDMA (Code Division Multiple Access), OFDM, or OFDMA (Orthogonal Frequency Division Multiple Access) are able to allocate adjacent cells on the same frequency by using orthogonal codes to separate cells, for example scrambling codes in CDMA networks, or pseudo-noise codes in OFDMA WiMAX. This allows a mobile to measure neighboring cells that share a common frequency simultaneously, i.e. during a time slot. Techniques described herein take advantage of this capability to improve the ability of mobiles to discover new cells.

For the case where all the cells are allocated on the same frequency, i.e., a frequency-reuse of 1, the serving cell may provide mobiles with the whole set of the orthogonal codes used in the network. During the allocated scanning time that the serving cell reserves for the mobile, the mobile first scans all the cells comprised in the NCL, then it uses the remaining time to discover other cells by using the provided orthogonal codes. Diagram 400 of FIG. 4 depicts an example of such new cell discovery within a timeslot.

For example, let K the maximum number of co-channel neighboring cells that the mobile can scan during one time slot, and let N be the number of neighboring cells in the NCL. The serving cell allocates at least T=┌N/K┐ time slots, where ┌x┐ denotes the smallest integer greater than the real value x. With T allocated time slots, after scanning N mandatory neighboring cells, the mobile has the ability to scan (T*K−N) new cells during the remaining time.

In principle, a mono-radio mobile (the mobile terminal is equipped with only one reception antenna) can not scan simultaneously cells of a different frequency. So for the general case of higher frequency-reuse patterns (the total frequency bandwidth is divided into a number of different sub-bands each of which is allocated to a number of cells in order to reduce the co-channel interference) we generalize the above solution that is proposed for the case of frequency-reuse 1. Assume that the cells of the NCL are partitioned into R different frequency sub-bands. We apply the solution used for frequency-reuse 1 to each partition of the NCL. It means that after finishing scan each partition of cells, the mobile uses the remaining time to discover new cells on the scanned frequency sub band. In this way, our neighbor cell discovery approach allows the discovery of new cells without any additional resources (although, the mobile may consume more energy).

To summarize, the basic idea behind these techniques is to use unused time within a given time-slot to detect new cells on the given frequency and unused time-slots (or dedicated time-slots) to detect new cells on other frequencies. For wireless technologies currently being developed, such a mechanism can be natively supported by the BS and MS. Further examples of how this may be implemented are described below.

Among the T time slots allocated for scanning, the serving BS specifies time slots {Timeslot-D1, Timeslot-D2, . . . } during which the mobile will discover new cells on some frequencies (“D” stands for “Discovery”). The serving BS will specify a frequency F_{D} for a Timeslot-D. During a given Timeslot-D the mobile will measure cells that are indicated in the NCL and on frequency F_{D}, and uses the remaining time to detect new neighboring cells on this frequency.

For example: the network uses three different frequencies {F₁, F₂, F₃}. The serving BS-1 has a neighboring cell list that is composed of 9 cells on F₁, 9 cells on F₂, and 7 cells on F₃. A mobile MS-A is capable of scanning 10 co-frequency cells per time slot.

The serving BS-1 allocates MS-A three time slots {T1, T2, T2} for scanning. As MS-A can scan 10 cells per time slot, the serving BS-1 may indicate three allocated time slots {T1, T2, T3} as discovery time slots, it means Timeslot-D1=T1, Timeslot-D2=T2, and Timeslot-D3=T3. During Timeslot-D1, the mobile MS-A will scan 9 cells of NCL and discover 1 new cell on frequency F₁. During Timeslot-D2, the mobile MS-A will scan 9 cells of NCL and discover 1 new cell on frequency F₂. And during Timeslot-D3, the mobile MS-A will scan 7 cells of NCL and discover 3 new cells on frequency F₃.

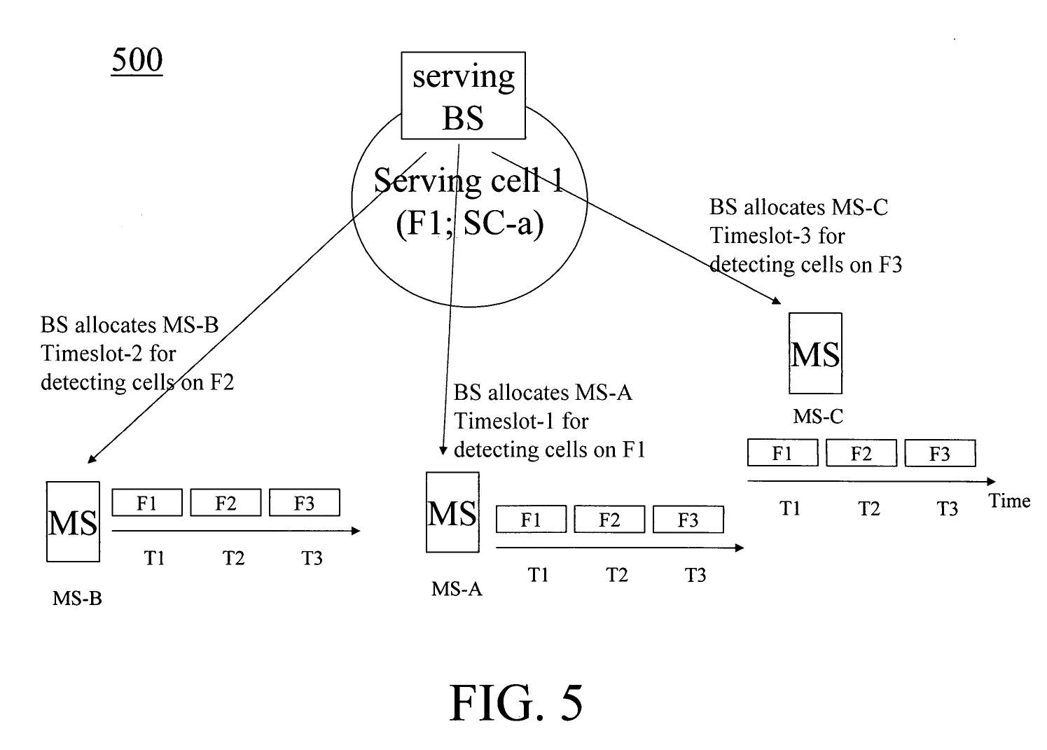

In order to maximize the discovery capability, the serving BS should calculate different Timeslot-D for different mobiles such that cells are discovered on all the frequencies used in the network. For example, some mobile MS-A does discovery on F₁, some other mobile MS-B does discovery on F₂, and some other MS-C does discovery on F₃. Diagram 500 of FIG. 5 depicts an example of such new cell discovery using multiple MSs.

In another implementation, the serving BS indicates six allocated time slots as discovery (two for each frequency), i.e., Timeslot-D={T1, T2, T3, T4, T5, T6}. And the mobile MS-A will scan F₁ cells during the first time slot, and in the second time-slot will be used to discover new cells on another frequency, e.g. F₈. In the same manner the third time slot will be used to discover F₂ cells and time-slot #4 will be used to discover new cells on a new sub-band, e.g. F₉. And so on.

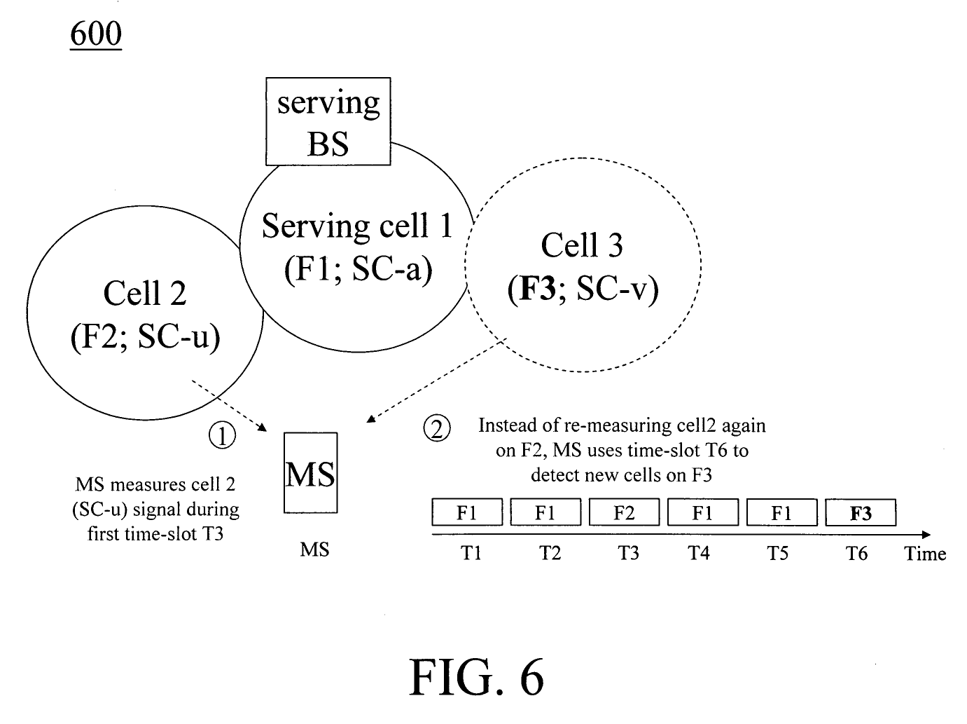

Diagram 600 of FIG. 6 depicts an example of such new cell discovery using multiple timeslots. In diagram 600, the MS measures the cell 2 (SC-u) signal during first time-slot T3. However, instead of re-measuring cell 2 on F2 during T6, the MS uses time-slot T6 to detect new cells on F3.

In addition, the mobile may need to know what scrambling codes are attributed to each frequency so that it can detect new cells. Two alternative approaches include random selection and scheduling-based selection. For random selection, during network entry of a mobile, the network communicates to this mobile the whole set of scrambling codes used in each frequency. Then, during time slots specified for neighbor discovery, the mobile can randomly select codes corresponding to the scanned frequency. In scheduling-based selection, for each time slot specified for neighbor discovery, the serving BS would additionally indicate codes for the mobile to discover.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for new cell discovery comprising:
sending, by a network node to a remote unit, an indication of at least one timeslot during which neighbor cell list (NCL) scanning is to be performed;
further indicating, by the network node to the remote unit, that the at least one timeslot is to be additionally used to search for signaling from cells not included in an NCL associated with the remote unit.

2. The method as recited in claim 1, further comprising:
indicating, by the network node to the remote unit, a frequency on which the NCL scanning is to be performed.

3. The method as recited in claim 1, further comprising:
indicating, by the network node to the remote unit, a first frequency on which at least one of NCL scanning or neighbor discovery is to be performed during a first timeslot of the at least one timeslot;
indicating, by the network node to the remote unit, a second frequency on which at least one of NCL scanning or neighbor discovery is to be performed during a second timeslot of the at least one timeslot.

4. The method as recited in claim 1, further comprising:
indicating, by the network node to the remote unit for neighbor discovery, at least one set of signaling codes for each of at least one frequency.

5. The method as recited in claim 1, further comprising:
indicating, by the network node to the remote unit, at least one signaling code for neighbor discovery during the at least one timeslot.

6. A method for new cell discovery comprising:
receiving by a remote unit an indication of at least one timeslot during which neighbor cell list (NCL) scanning is to be performed;
measuring, by the remote unit during the at least one timeslot, signaling from at least one cell included in an NCL associated with the remote unit;
searching, by the remote unit during the at least one timeslot, for signaling from cells not included in the NCL.

7. The method as recited in claim 6, further comprising:
receiving by the remote unit an indication of a first frequency on which NCL scanning is to be performed.

8. The method as recited in claim 7,
wherein measuring signaling from the at least one cell included in the NCL associated with the remote unit comprises
measuring signaling, on the first frequency, from at least one cell included in the NCL, and
wherein searching for signaling from cells not included in the NCL comprises
searching for signaling, on the first frequency, from cells not included in the NCL.

9. The method as recited in claim 6, further comprising:
receiving by the remote unit an indication of a first frequency on which at least one of measuring signaling or searching for signaling is to be performed during a first timeslot of the at least one timeslot;
receiving by the remote unit an indication of a second frequency on which at least one of measuring signaling or searching for signaling is to be performed during a second timeslot of the at least one timeslot.

10. The method as recited in claim 9,
wherein searching, by the remote unit during the at least one timeslot, for signaling from cells not included in the NCL comprises
searching for signaling, on the second frequency during the second timeslot, from cells not included in the NCL.

11. The method as recited in claim 6, further comprising:
receiving by the remote unit an indication of a set of signaling codes associated with a first frequency.

12. The method as recited in claim 11, wherein searching for signaling from cells not included in the NCL comprises:
selecting a code from the set of signaling codes associated with the first frequency;
searching for signaling, on the first frequency, from cells using the selected code.

13. The method as recited in claim 6, further comprising:
receiving by the remote unit an indication of at least one signaling code for neighbor discovery.

14. The method as recited in claim 13, wherein searching for signaling from cells not included in the NCL comprises:
searching for signaling from cells using a code from the at least one signaling code.

15. A network node comprising:
a transceiver;
a processing unit, communicatively coupled to the transceiver,
adapted to send, to a remote unit via the transceiver, an indication of at least one timeslot during which neighbor cell list (NCL) scanning is to be performed, and
adapted to further indicate, to the remote unit via the transceiver, that the at least one timeslot is to be additionally used to search for signaling from cells not included in an NCL associated with the remote unit.

16. A remote unit comprising:
a transceiver;
a processing unit, communicatively coupled to the transceiver,
adapted to receive via the transceiver an indication of at least one timeslot during which neighbor cell list (NCL) scanning is to be performed,
adapted to measure, via the transceiver during the at least one timeslot, signaling from at least one cell included in an NCL associated with the remote unit, and
adapted to search, via the transceiver during the at least one timeslot, for signaling from cells not included in the NCL.
